(19) United States
(12) Patent Application Publication
(10) Pub. No.: US 2019/0347699 A1
(43) Pub. Date: Nov. 14, 2019

(54) SYSTEM, METHOD, AND PLATFORM FOR MANAGING TRANSACTIONS SUPPORTING CAUSES

(71) Applicant: Xenia, LLC, San Diego, CA (US)

(72) Inventors: Torrie Bradley, San Diego, CA (US); Nathaniel T. Bradley, Tuscon, AZ (US)

(73) Assignee: Xenia, LLC, San Diego, CA (US)

(21) Appl. No.: 16/412,094

(22) Filed: May 14, 2019

Related U.S. Application Data
(60) Provisional application No. 62/671,308, filed on May 14, 2018.

(51) Int. Cl. G06Q 30/02; G06Q 30/00; G06Q 50/30

(52) U.S. Cl. CPC G06Q 30/0279; G06Q 50/30; G06Q 30/018

(57) ABSTRACT

A system, method, and platform for compiling information for businesses supporting causes. Information is received from a business supporting one or more causes. The one or more causes supported by the business are verified. A determination is made whether the one or more causes are verified. Goods and services offered by the business are communicated in response to the one or more causes being verified.

### PRIORITY STATEMENT

This application claims priority to U.S. Provisional Patent Application No. 62/671,308 filed on May 14, 2018, which is entitled System, Method, and Platform for Managing Transactions Supporting Causes which is hereby incorporated by reference in its entirety.

### BACKGROUND

### I. Field of the Disclosure

The illustrative embodiments relate to purchases. More specifically, but not exclusively, the illustrative embodiments relate to a system, method, apparatus, and platform for performing, managing, and tracking purchases that support causes whether charitable or otherwise.

### II. Description of the Art

In recent years e-commerce, website purchases, and other forms of online shopping have grown exponentially. Many companies that sell goods and services support causes or adhere to principles that people find important. In many cases it is difficult to verify the authenticity of the causes each provider, retailer, or entity legitimately contributes to or supports. As a result, effectively supporting causes through the purchases of services and products may be difficult and time consuming.

### SUMMARY OF THE DISCLOSURE

The illustrative embodiments provide a system, method, and platform for compiling information for businesses supporting causes. Information is received from a business supporting one or more causes. The one or more causes supported by the business are verified. A determination is made whether the one or more causes are verified. Goods and services offered by the business are communicated in response to the one or more causes being verified. In another embodiment, the system and platform include a processor and a memory storing a set of instructions. The set of instructions are executed by the processor to perform the method herein described.

### BRIEF DESCRIPTION OF THE DRAWINGS

Illustrated embodiments are described in detail below with reference to the attached drawing figures, which are incorporated by reference herein, and where:

FIG. 1 is a pictorial representation of a system for managing cause-based purchases and services in accordance with an illustrative embodiment.

FIG. 2 further illustrates portions of the system of FIG. 1 in accordance with an illustrative embodiment;

FIG. 3 is a flowchart of a process for verifying causes supported by a business in accordance with an illustrative embodiment;

FIG. 4 is a flowchart of a process for communicating causes supported through purchases in accordance with an illustrative embodiment;

FIG. 5 is a flowchart of a process for tracking causes supported by a purchase in accordance with an illustrative embodiment;

FIG. 6 is a pictorial representation of a transaction summary 600 in accordance with an illustrative embodiment; and

FIG. 7 depicts a computing system 700 in accordance with an illustrative embodiment.

### DETAILED DESCRIPTION OF THE DISCLOSURE

The current trends in consumer, corporate, foundation and family-based giving, and other forms of philanthropy have shifted towards crowd funding. This is especially true of cause-based shopping within the retail and consumer product goods sectors. Recent studies confirm that the vast majority of philanthropic giving around the world has shifted to crowd funding models and brands. For example, consumer products have begun to align with marketing that is utilized for social, medical, disease, biological, zoological, environmental, plant and habitat, disaster relief, and promotion of humane causes. The results of these efforts are often measured by the compound and rolling social impact model that is being directly integrated in the marketing of brands in business. In many cases, there are brands that have philanthropy built into their business model, however, the challenge lies in the lack of the ability for consumers to find these brands easily and verifying the giving and the true impact of these brands as true and accurate. The problem is compounded by the fact that smaller organizations have diverted funds from marketing because a larger portion of their profits are used to give back and/or support their cause-based programs. On a worldwide basis, brands and organizations are making changes to have an impact on the world with, in some cases, proceeds from each purchase of products, goods, and services that they provide.

The illustrative embodiments provide a system, method, and platform for distributing information and access to businesses that verifiably support worthwhile and charitable causes and initiatives. In one embodiment, a platform receives information for numerous businesses that purport to support worthwhile and charitable causes, actions, programs, and initiatives. The platform verifies the causes supported by the businesses by determining whether donations, time, and support are provided by the businesses as asserted. Any number of electronic and user resources and efforts may be utilized to verify the businesses support of their purported causes. If the verification is successful, the platform adds the businesses as an authorized or certified business (e.g., Xenia certified). As a result, the businesses are added to the platform as a verified partner with applicable information associated with the businesses and supported causes uploaded and displayed by the platform.

One embodiment provides a networked system, method, and apparatus for the automation of philanthropy, consumer giving, and cause pooling with a management capability that allows for the verification and ranking of organizational giving. The illustrative embodiments provide for a marketplace that provides access to all of the brands, services and organizations, small and large, on an internet connected philanthropy platform in which consumers may experience a one-stop shopping experience for all the businesses, brand, and products that currently have a social impact model offering built into the purchase, rebate, or giving program related to their product/services. In the past, philanthropy has been largely reserved for the rich and wealthy organizations. The illustrative embodiments provide for leveling of the playing field and the creation of crowd funding and scalable disaster relief and other means of consolidating the cause-based giving, while validating and verifying the amounts and true impacts related to giving.

One embodiment provides a system, method, device, mobile application and computer program for users to find, interact with, and purchase from brands who have a validated and verified social impact. The online and/or interne connected platform, as well as, the brick and mortar stores carry rights to resell products and services from businesses that have a tangible social impact model built into their business.

Another embodiment provides a way for businesses that have a social impact model to be represented on the ecommerce platform and/or the brick and mortar store, while either maintaining their own website or using the system, method, device, mobile application, and computer programs available to market, host, and sell the products and services these businesses are selling directly or indirectly (or to enhance their efforts).

Another embodiment provides a system, method, device, mobile application, and computer program for a consumer to search and filter products and services in any manner, such as for meaningful shopping and acquisition of goods and services. The consumer may search and filter information and data utilizing any portion of the system, method, device, mobile application, and computer program in order to shop by a specified cause. The consumer may also search, and filter results based on cause, region of the world, celebrity endorsements, best rating, corporate/organization principals, highest impact, and so forth.

Another embodiment provides a resource for the consumer to view, at a glance, a score card of the validity of the business model of each brand that is represented. Each of the businesses, organizations, or individuals represented in the platform may have a summary of who they are, and the causes, principles, donations, or actions supported or provided.

Another embodiment provides a running tally of every single impact each consumer has had on the world in a live ticker, pop up, summary, messages, or similar formula displayed with infographics, detailing the total number and types of causes supported based on applicable purchases.

Another embodiment provides a checkout system that provides the most secure check out possible, collecting the least information possible in order to fulfill the order in a timely matter and accepting any form of payment currently acknowledged by a FDIC insured bank including but not limited to, bitcoin, credit card, PayPal, Dwolla, Amazon Pay, Venmo, Zelle, direct deposit, electronic checks, and Apple Pay. Another embodiment provides a receipt upon a completed purchase to be sent to the consumer both electronically and physically that details each social impact that they purchased through that singular purchase.

Another embodiment provides specific cause-based marketing. Once a user has searched, browsed, or purchased a good or service connected with a specific cause, the platform will immediately rework the way the goods are presented on the landing page and all personalized marketing campaigns to include and/or focus on the singular cause that the consumer had originally interacted with or sought out.

Another embodiment is a rating practice in which the customers may not only rate and review the products and services, but also the businesses, organizations, entities, or individuals (collectively businesses) they have decided to purchase from. In turn, the businesses have a portion of the platform designated to sharing the impact that they have had on society due strictly to the purchases made through the platform, system, method, device, mobile application, and computer program mentioned previously.

Another embodiment is to provide a virtual and/or internet connected experience to the consumer through, including, but not limited to, their computer, handheld device, wearable technology, and or internet connected device in which the consumer may outfit themselves and/or a room in their house with the goods selected in order to specifically see the impact all of their purchases an outfit or house decor/redesign may have.

Another embodiment is to provide a brick and mortar store in which, upon entering, the retail store and retail store personnel are directly informed of causes that the consumer is passionate about and has shopped for or sought out before, in order to lead them to, suggest, and market to them specific products based on their prior purchases.

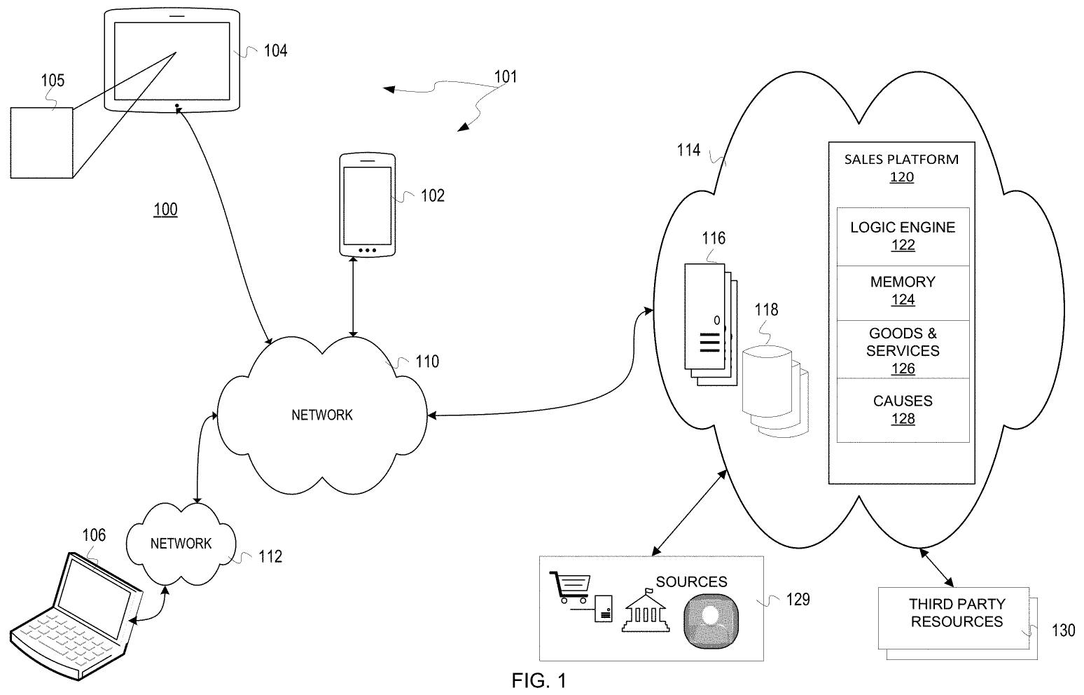

FIG. 1 is a pictorial representation of a system 100 for managing cause-based purchases and services in accordance with an illustrative embodiment. In one embodiment, the system 100 of FIG. 1 may include any number of devices 101, networks, components, software, hardware, and so forth. In one example, the system 100 may include a smart phone 102, a tablet 104 displaying a graphical user interface 105, a laptop 106 (altogether devices 101), a network 110, a network 112, a cloud system 114, servers 116, databases 118, a sales platform 120 including at least a logic engine 122 and a memory 124. The cloud system 114 may further communicate with sources 129 and third-party resources 130.

Each of the devices, systems, and equipment of the system 100 may include any number of computing and telecommunications components, devices or elements which may include processors, memories, caches, busses, motherboards, chips, traces, wires, pins, circuits, ports, interfaces, cards, converters, adapters, connections, transceivers, displays, antennas, operating systems, kernels, modules, scripts, firmware, sets of instructions, and other similar components and software that are not described herein for purposes of simplicity.

In one embodiment, the system 100 may be utilized by any number of users, organizations, or providers to aggregate, manage, review, analyze, process, advertise, market, display, and/or distribute products and services as well as the causes supported by the products and services. In one embodiment, the goods and services represent any number of items, content, products, goods, or services sold by a business, entity, organization, or entity. In one embodiment, the system 100 may utilize any number of secure identifiers (e.g., passwords, pin numbers, certificates, etc.), secure channels, connections, or links, virtual private networks, biometrics, or so forth to upload, manage, and secure the goods and services and process applicable transactions. The devices 101 are representative of multiple devices that may be utilized by businesses or consumers, including consumer, network, and business devices and associated operating systems, programs, sets of instruction, scripts, kernels, and other software, and may also include devices integrated with or utilized by the cloud system 114. The devices 101 utilize any number of applications, browsers, gateways, bridges, or interfaces to communicate with the cloud system 114, platform 120, and/or associated components.

The wireless device 102, tablet 104, and laptop 106 are examples of common devices that may be utilized to manage available goods and services or perform transactions related thereto. Other examples of devices 101 may include e-readers, cameras, video cameras, audio systems, gaming devices, vehicle systems, art systems, kiosks, point of sale systems, televisions, smart displays, monitors, entertainment devices, medical devices, virtual reality/augmented reality systems, or so forth. The devices 101 may communicate wirelessly or through any number of fixed/hardwired connections, networks, signals, protocols, formats, or so forth. In one embodiment, the smart phone 102 is a cell phone that communicates with the network 110 through a 5G connection. The laptop 106 may communicate with the network 112 through an Ethernet, cellular, or Wi-Fi connection.

The cloud system 114 may aggregate, manage, analyze, and process content and user requests across the Internet and any number of networks, sources 129, and third-party resources 130. For example, the networks 110, 112, 114 may represent any number of public, private, virtual, specialty, or other network types or configurations. The different components of the system 100, including the devices 101 may be configured to communicate using wireless communications, such as Bluetooth, Wi-Fi, or so forth. Alternatively, the devices 101 may communicate utilizing satellite connections, Wi-Fi, 3G, 4G, 5G, LTE, personal communications systems, DMA wireless networks, and/or hardwired connections, such as fiber optics, T1, cable, DSL, high speed trunks, powerline communications, and telephone lines. Any number of communications architectures including client-server, network rings, peer-to-peer, n-tier, application server, mesh networks, fog networks, or other distributed or network system architectures may be utilized. The networks, 110, 112, 114 of the system 100 may represent a single communication service provider or multiple communications services providers.

The sources 129 may represent any number of web servers, distribution services (e.g., text, email, video, etc.), media servers, platforms, distribution devices, or so forth. In one embodiment, the sources 129 may represent the businesses that sell and make available goods and services utilizing the system 100. The cloud system 114 (or alternatively the cloud network) including the sales platform 120 is specially configured to perform the illustrative embodiments.

The sources 129 may also represent social media networks and services or social media may be accessed utilizing applications, browsers, or software on the devices 101. The users may share one or more of sellers, goods and services, associated causes, and messages, thought, and content regarding any of the above. As a result, positive or negative information may be utilized to influence other potential purchasers. In particular, users that support the same causes and have similar needs/wants for goods and services may be able to make concerted efforts. For example, a user may share on social media that carpet cleaning services offered at a discount support a local art group while encouraging people to use their services. Positive peer pressure may be utilized to support different efforts.

The cloud system 114 or network represents a cloud computing environment and network utilized to aggregate, process, manage, sell, and distribute content and support the associated causes. The cloud system 114 allows goods and services from multiple businesses, users, managers, or service providers to be centralized. In addition, the cloud system 114 may remotely manage configuration, software, and computation resources for the devices of the system 100, such as devices 101. The cloud system 114 may prevent unauthorized access to data, tools, and resources stored in the servers 116, databases 118, and well as any number of associated secured connections, virtual resources, modules, applications, components, devices, or so forth. In addition, a business may more quickly upload, aggregate, process, manage, and distribute goods and services, where authorized, utilizing the cloud resources of the cloud system 114 and sales platform 120. In addition, the cloud system 114 facilitates distribution of cause information and dated associated with the business. The cloud system 114 allows the overall system 100 to be scalable for quickly adding and removing businesses, users, authorized sellers, cause-based information, analysis modules, moderators, programs, scripts, filters, transaction processes, distribution partners, or other users, devices, processes, or resources. Communications with the cloud system 114 may utilize encryption, secure tunnels, handshakes, secure identifiers (e.g., passwords, pins, keys, scripts, biometrics, etc.), firewalls, specialized software modules, or other data security systems and methodologies as are known in the art.

Although not shown, the cloud system 114 may include any number of load balancers. The load balancer is one or more devices configured to distribute the workload of processing the uploaded goods and services as well as applicable transactions to optimize resource utilization, throughput, and minimize response time and overload. For example, the load balancer may represent a multilayer switch, database load balancer, or a domain name system server. The load balancer may facilitate communications and functionality (e.g. database queries, read requests, write requests, command communications, stream processing, etc.) between the devices 101 and the cloud system 114. For example, the cloud system 114 may offload verification information for new businesses that seek to be added to the system 100 along with applicable goods and services information. Load balancing may be performed between automatic systems and devices as well as individual users. Other intelligent network devices may also be utilized within the cloud system 114.

The servers 116 and databases 118 may represent a portion of the sales platform 120. In one embodiment, the servers 116 may include a web server 117 utilized to provide a website and user interface (e.g., user interface 107) for interfacing with numerous users. Information received by the web server 117 may be managed by the sales platform 120 managing the servers 116 and associated databases 118. For example, the web server 117 may communicate with the database 118 to respond to read and write requests. The databases 118 may utilize any number of database architectures and database management systems (DBMS) as are known in the art. The databases 118 may store the content associated with each consumer/purchaser/user which may specify an address, name, age, biometric identifiers, payment information, location, cause preferences, cause restrictions, and so forth. The database 1108 may also store information relating to sellers including products/items/services, causes supported, charitable information (e.g., contribution information, percentages, details, etc.), and so forth. Any number of secure identifiers, such as inaudible tones, QR codes, serial numbers, or so forth may be utilized to ensure that content, personal, or transaction information is not improperly shared or accessed.

In one embodiment, the user interface 105 is a portion of a sales application (not shown) executed by the devices 101. For example, the user interface 105 may represent the portion of the sales platform visible to the user for communicating and receiving information, data, and content. The user interface 105 may be made available through the various devices 101 of the system 100. In one embodiment, the user interface 105 represents a graphical user interface, audio interface, or other interface that may be utilized to communicate, display, receive, and otherwise manage data and information. For example, the user may navigate products and services that support causes and interests associated with the user utilizing the user interface 105. The user interface 105 may utilizer any number of windows, icons, drop-down menus, graphics, images, and content The graphical user interface 105 may be presented based on execution of one or more applications, browsers, kernels, modules, scripts, operating systems, or specialized software that is executed by one of the respective devices 101. The user interface may display current and historical data as well as trends. The user interface 105 may be utilized to set the user preferences, parameters, and configurations of the devices 101 as well as upload and manage the content sent to the cloud system 114.

In one embodiment, the system 100 or the cloud system 114 may also include the sales platform 120 which is one or more devices utilized to enable, initiate, aggregate, analyze, process, and manage goods, services, causes, and so forth with one or more communications or computing devices. The sales platform 120 may include one or more devices networked to manage the cloud network and system 114. For example, the sales platform 120 may include any number of servers, routers, switches, or advanced intelligent network devices. For example, the sales platform 120 may represent one or more web servers that performs the processes and methods herein described.

In one embodiment, the logic engine 122 is the logic that controls various algorithms, programs, hardware, and software that interact to receive, aggregate, analyze, rank, process, score, communicate, and distribute goods and services, content, alerts, reports, messages, or so forth. The logic engine 122 may utilize any number of thresholds, parameters, criteria, algorithms, instructions, or feedback to interact with users and interested parties and to perform other automated processes. The logic engine 122 may represent a processor. The processor is circuitry or logic enabled to control execution of a program, application, operating system, macro, kernel, or other set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor may be a single chip or integrated with other computing or communications elements.

The memory 124 is a hardware element, device, or recording media configured to store data for subsequent retrieval or access at a later time. The memory 124 may be static or dynamic memory. The memory 124 may include a hard disk, random access memory, cache, removable media drive, mass storage, or configuration suitable as storage for data, instructions, and information. In one embodiment, the memory 124 and logic engine 122 may be integrated. The memory 124 may use any type of volatile or non-volatile storage techniques and mediums.

In one embodiment, cloud system 114 or the sales platform 120 may coordinate the methods and processes described herein as well as software synchronization, communication, and processes. The third-party resources 130 may represent any number of human or electronic resources utilized by the cloud system 114 including, but not limited to, businesses, entities, organizations, individuals, government databases, private databases, web servers, research services, service providers, and so forth. For example, verification of charitable giving (e.g., time, resources, money, etc.) may be verified through any number of auditing groups, charitable organizations, watchdog groups, or so forth.

In one embodiment, the sales platform 120 may implement a blockchain ledger, manager, or technology. In another embodiment, the blockchain ledger may be accessible through sources 129. Any number of existing blockchain companies or providers may be utilized (Aeternity, Ethereum, Bitcoin, Dfinity, ContentKid, Blockphase, Chain of Things, Flowchain, Decissio, Cognate, SkyHive, Safe, etc.).

The blockchain 126 is utilized as a way to store and communicate goods and services along with supported causes. The blockchain 126 may utilized one or more distinct ledgers for different entities, services providers, types of products, users, or so forth. For example, each new seller (or product, good, or service) received by the sales platform 120 is assigned a secure identifier. In one embodiment, the secure identifier is an inaudible tone or other key that may be integrated into a product listing, profile, or other information for securing and authenticating the sellers, goods/services, supported causes, and so forth. The blockchain 126 may cross-reference updates to the content with the original record for the content to ensure proper licensing, management, and transactions. In one example, different licensing tiers, pricing algorithms, license verification, inaudible tone verification, cause information, and payments are combined to create a unique platform. The illustrative embodiments provide a system 100, cloud system 114, and sales platform 120 for compiling businesses that support causes and documenting consumer transactions that support those causes.

The blockchain may also utilize any number of payment systems (e.g., PayPal, Venmo, Dwolla, wire transfers, credit cards, Quicken, etc.) to receive money and distribute payments. In one embodiment, the sales platform 120 may receive a small fee or percentage per transaction, purchased item, browsing session, or so forth.

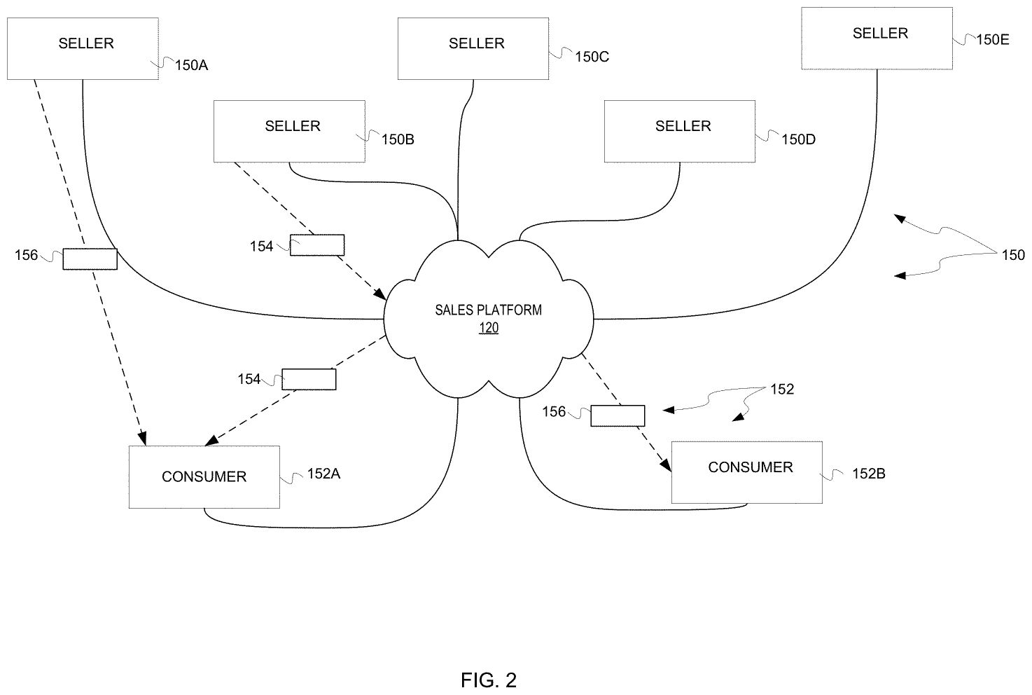

In one embodiment, the sales platform 120 may be utilized to verify sellers and associated goods and services 126 and causes 128 associated with the goods and services 126. The sales platform 120 may utilize an application or application eco system utilized by the devices 101 to automatically determine and retrieve applicable data, information, and content associated with the sellers, goods and services 126, and causes 128. In one embodiment, an initial account setup process may be utilized by the users and sellers. Thereafter, information may be automatically retrieved from systems, devices, accounts, services, programs, operating systems or other hardware or software devices or interfaces utilized by the users or sellers (see the devices of FIGS. 1 and 2).

The third-party resources 130 may represent any number of electronic or other resources that may be accessed to perform the processes herein described. For example, the third-party resources 130 may represent government, private, and charitable servers, databases, websites, services, and so forth for verifying charitable contributions. In another example, auditors may verify information provided by businesses with regard to the causes 128 associated with the businesses themselves or their associated goods and services 126.

In one embodiment, the sales platform 120 may distribute electronic (e.g., in-application messages, email messages, text messages, etc.) and/or print notifications and messages to the user and sellers. For example, sellers may be notified if and when their products and services are certified by the sales platform 120 for platform inclusion, sales, and marketing. The sellers may also be notified when additional information, data, or details are required to verify the causes they acknowledge supporting.

FIG. 2 further illustrates portions of the system 100 of FIG. 1 in accordance with an illustrative embodiment. As shown the sellers 150A-E (jointly sellers 150) may represent the sources 129 of FIG. 1. The sellers 150 may represent any number of businesses, retailers, service providers, individuals, organizations, entities, or so forth referred to as sellers 150 or businesses for purposes of simplicity. The consumers 152A, 152B (jointly consumers 152) represent any number of buyers, users, consumers, groups, or individuals that purchase goods and services from the sellers 150 as performed through or enabled by the sales platform 114. In one embodiment, the sales platform 114 may represent all or portions of the system 100 of FIG. 1 (including the cloud system 114, servers 116, databases 118). The sellers 150 may submit goods, services, products, and cause information that is aggregated, stored, and verified by the sales platform 120. As previously noted, the sales platform 120 may also represent one or more manufacturing or distribution centers, systems, devices, facilities, or so forth. The sellers 150 and consumers 152 may represent any number of individuals or groups (e.g., hundreds, thousands, millions, etc.).

As noted, the sellers 150 may send or distribute goods and services 154 through distribution systems (e.g., delivery networks, brick and mortar stores, etc.), the cloud system 114, or directly to the consumers 152. In one embodiment, the seller 150B may distribute goods and services 154 to the consumer 152A through the sales platform 120. The sales platform 120 may perform distribution of the goods and services 154. For example, the sales platform 120 may include any number of physical storage, digital storage, warehousing, and distribution systems, facilities, professionals, employees, contractors, electronics, and so forth.

In another embodiment, the seller 150A may provide information to the consumer 152A through the sales platform, but distribution of goods and services 156 may occur directly between the seller 150A and the consumer 152A. As a result, the sales platform 120 may facilitate the advertising, marketing, information distribution and retrieval, and sales process without performing distribution. For example, the sales platform 120 may track or monitor referrals or transactions that are enabled by the sales platform 120 to receive a referral fee, payment percentages, royalties/licenses, transaction fees, or other agreed upon payments. Distribution of the goods and services 156 may also be performed from or through the sales platform 120, such as delivery of goods and services 156 from the seller 150B to the sales platform 120 and then from the sales platform 120 to the consumer 152B.

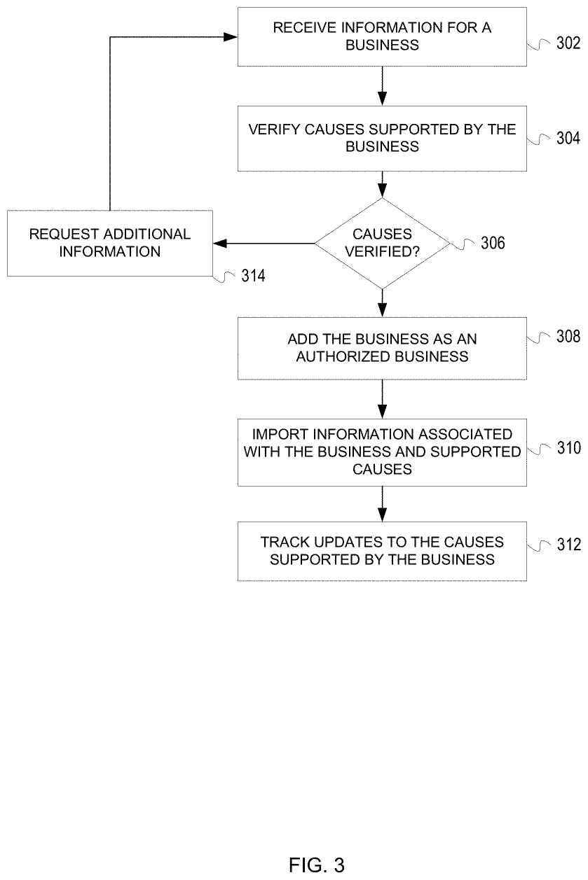

FIG. 3 is a flowchart of a process for verifying causes supported by a business in accordance with an illustrative embodiment. The process of FIGS. 3-5 may be performed by a platform, device, server, or other equipment in accordance with illustrative embodiments (referenced as a platform). All or portions of the process of FIG. 3 may be performed automatically. In one embodiment, the process may begin by receiving information for a business (step 302). The business may represent any number of corporations, entities, individuals, groups, or collaborations (of any size) that may sell goods or services. The business may submit an application, form, disclosure, request, or other data and information to the platform. The application may require vetting or authorization before the business is authorized. The platform may alternatively seek out businesses or information utilizing web crawlers, searching algorithms, data analytics, and so forth. In another embodiment, users may retrieve information applicable to the business from any number of electronics or physical sources, such as websites, advertisements, marketing brochures, e-brochures, pamphlets, word-of-mouth, reviews, user references, recommendation sites, and so forth.

Next, the platform verifies causes supported by the business (step 304). The verification may be performed utilizing electronic and physical resources. For example, the platform may automatically search databases, records, statements, and other applicable data and information that verifies money, effort, hours, and other material contributions or support from the business to the specified cause(s). The applicable information may also be gathered together as a resource for a user or administrator responsible for performing ultimate verification. In one embodiment, the platform may send one or more messages (e.g., emails, in-application messages, phone calls, texts, written requests, etc.) to verify that the causes are supported. For example, email messages may be sent to email addresses on record for the charitable cause. The message may specify the contribution that the business has purportedly made with a yes or no verification available. In some embodiments, multiple verifications may need to be performed for different products/services, charitable organizations/causes/interests, contribution levels, and so forth. Verification efforts may be supplemented by human interactions, input, intelligence, or verification as required.

Next, the platform determines whether the causes are verified (step 306). The verification may be determined utilizing all of the data and information previously noted. In one example, verification of all or a majority of the causes associated with the business may ensure that the business is able to participate as an authorized business on the platform. In another example, if donations of money purported to be made by the businesses cannot be verified, the cause is not verified in step 306. For example, a rejection communication may be sent to the business or a request for additional information as is described below.

Next, the platform adds the business as an authorized business (step 308). In one embodiment, the authorized business may be assigned a number, verification code, or other relevant information. The authorized business may also be given permission to indicate a certification (e.g., Xenia Certified, Doing Good Verified, etc.). Any number of proprietary or protected logos marks, pins, digital certificates, passwords, encryption schemes, or other digital authentications may be utilized.

Next, the platform imports information associated with the business and supported causes (step 310). In one embodiment, the platform may present an interface for the business to provide specific information. For example, the information may specify the amount and types of contributions (e.g., money, time/hours, services, in-kind contributions, etc.), actions, taken, dates, recipients, transaction information, tax information, and causes supported. Specific products, services, or purchase amounts may be associated with detailed information regarding donations, hours served, and so forth. The platform may also import accounting, statistical, audited information, or other data about the business and supported causes. The platform or platform service provider may provide application program interfaces, programs, scripts, or tools for automatically sending and receiving the needed information. As a result, even if some of the applicable information is manually entered by the business, the platform may be able to automatically receive or import the information.

Next, the platform tracks updates to the causes supported by the business (step 312). As noted, the businesses may be provided a designated website, program, application program interface, script, interface, username and password, access point, or other system or process for providing updated information. Updates are used to add new products, services, causes, charitable contribution amounts, and so forth. The updates may be received over hours, days, weeks, months, or years.

If the causes are not verified for the business during step 306, the platform requests additional information (step 314). The additional information may be utilized to further vet the business before it can be added to the platform. During step 314 a message or communication may be sent to the business indicating that the causes associated with the business have not been verified, rejected, or require additional information.

The process of FIG. 3 ensures that businesses are fully vetted to ensure that they do contribute as advertised. Verification provides users of the platform increased assurances and confidence in their financial purchases or investments through the platform. The processes and steps of FIGS. 3-5 may be combined, interchanged, or performed sequentially, concurrently, or simultaneously.

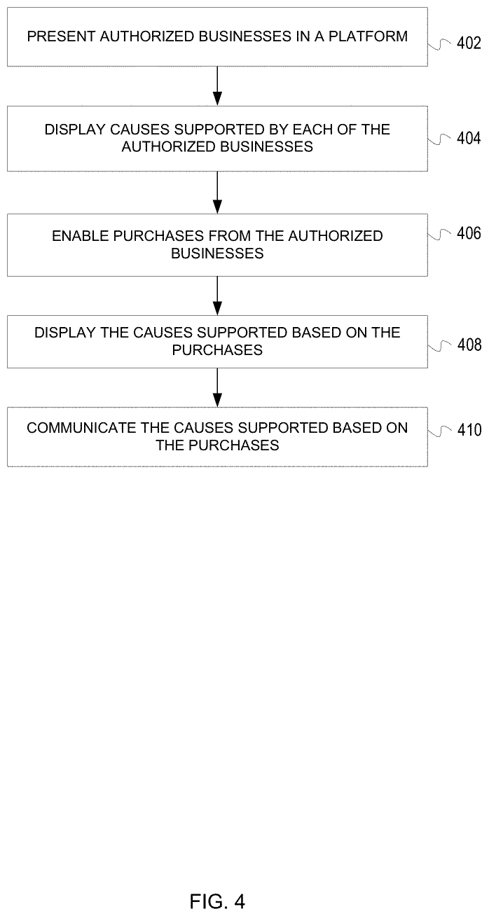

FIG. 4 is a flowchart of a process for communicating causes supported through purchases in accordance with an illustrative embodiment. In one embodiment, the process of FIG. 4 may begin by presenting authorized businesses utilizing a platform (step 402). The businesses may be presented utilizing the platform. The platform may represent or be utilized by one or more websites, mobile applications, programs, emails, advertisements, or so forth. The authorized businesses may all have been vetted, verified, and otherwise authorized to utilize the platform using the process of FIG. 3).

In one embodiment, the products and services associated with each business may also be displayed in step 402. For example, common products and services may include clothes, shoes, electronics, vehicles, food, professional services (e.g., accounting services, medical/healthcare services, legal services, management services, financial services, insurance services, engineering services, etc.), cleaning services, medical device, pharmaceuticals, logistics/transportation, construction, real estate, vehicles, information technology services, industrial services, food services, travel services, and so forth. The platform may display products and services that may be directly purchased or may link to resources where they may he purchased. Any number of specialized links, codes, digital certificates, cookies, or other information may be utilized to track consumption and utilization of the content, information, and data associated with the authorized business presented by the platform.

Next, the platform displays causes supported by each of the authorized businesses (step 404). The causes may generally be associated with one or more businesses. For example, charitable organizations associated with a shoe company may be listed. Additionally, the amounts and types of support provided by the businesses may be communicated. For example, a shoe company may indicate that for every shoe that is bought one is donated to a child in poverty in a specified geographic. Actions, donation amounts, donation types, services rendered, regions benefited, and other details regarding the causes supported by each of the authorized businesses and their associated products/services. The information may be presented visually/graphically, audibly, using video, or any combination thereof.

Next, the platform enables purchases from the authorized businesses (step 406). The platform may enable direct transactions or indirect transactions utilizing links, pop-ups, or so forth. In addition, any number of websites, distributors, wholesalers, or third-parties may be utilized. In one embodiment, the platform may provide a dedicated website, mobile application, and computer program that may be utilized to search, filter, and navigate the authorized businesses, associated goods and services, and applicable causes. In one embodiment, money, currency, tokens, or other renumeration may be accepted directly by the platform and distributed to the business, causes, or other applicable parties by the platform. In another embodiment, the individual business may accept payments and support their cause(s) as advertised to consumers. In one embodiment, the platform may operate as a non-profit or charitable institution itself. In another embodiment, the platform may accept small payments or referral/affiliate payments for the resources, network, platform, and services provided.

Next, the platform displays the causes supported based on the purchases (step 408). Step 408 indicates the amount, type, level, support, and other cause information that is provided in response to the user's purchase. As noted, the causes supported may vary by specific product and service purchased. Thus, the information and data specific to the transaction may be communicated to the user.

Next, the platform communicates the causes supported based on the purchases (step 410). In one embodiment, a receipt is sent for the transaction indicating the product/services ordered, amounts, price, and the causes supported based on the transaction. The information, data, and transaction details including the causes supported may be sent in any number of formats. In one example, an email, text, or in-application message may be communicated to the user to reduce physical resources utilized. In another example, a printing and shipping service may receive a file or document with the relevant information before printing and shipping the document.

The causes supported by the user may also be display per category, time period, or other relevant information. Different types of selections or filtering may be applied. In one example, the user may be able to see the causes and details of support for those causes that were provided through their purchases for the current year or in the last twelve months. The information may even specify a portion of the transaction that is tax deductible or considered a charitable gift as allowed by applicable laws.

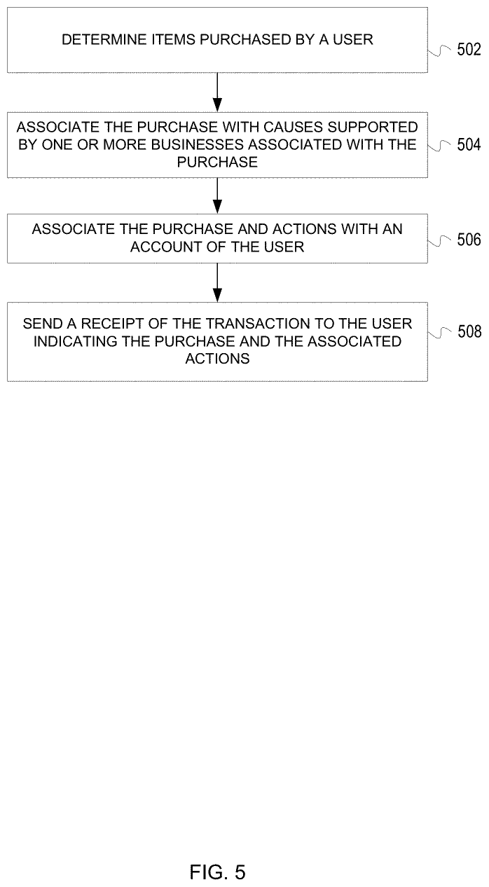

FIG. 5 is a flowchart of a process for tracking causes supported by a purchase in accordance with an illustrative embodiment. The process beings by determining items purchased by a user (step 502). The purchased items may represent products or services as previously noted. The items may be tracked utilizing carts, databases, discreet messages, cookies, messages, identifiers, tracking information, or so forth. In one embodiment, the platform tracks items purchased by numerous users across multiple businesses associated with the platform.

Next, the platform associates the purchases with causes supported by one or more businesses associated with the purchase (step 504). The causes and actions may represent charitable, environmental, monetary, service, or other activities supported by the business associated with the purchased goods or services. Different items from a single business may have different actions associated with their purchase. For example, food purchases may support feeding hungry children locally whereas clothing purchases may support individuals that suffer from domestic abuse. Some examples of common charitable causes and activities may include disease/treatment and prevention, medical services, addressing homelessness, mental illness, job/employment/education, vaccinations, literacy initiatives, food and water distribution, affordable housing, animal/pet services and protection, environment/conservation, arts/cultures/humanities, churches, disaster relief, peace and human rights, child sponsorship, scholarships, performing arts, historical societies, public broadcast and media, reform initiatives, and other applicable charities.

Next, the platform associates the purchase and supported causes with an account of the user (step 506). The user is credit for performing or assisting the cause in response to their purchase of the items. In some jurisdictions or countries, the user may be able to claim a tax credit, subsidiary, or benefit for their purchase of the times. As a result, the platform tracks the purchases made by each user through the platform. Users may also receive plaques, certificates, awards, or other recognition for significantly supporting one or more causes.

Next, the platform sends a receipt of the transaction to the user indicating the purchase and the associated actions (step 508). As noted, the receipt may be sent electronically (e.g., email, text, in-app message, etc.) or in physical format. The receipt may also be displayed at the user's request or automatically in response to the user accessing the platform. For example, a “Causes Supported” indicator or tab may allow the user to select to view the causes supported by purchase.

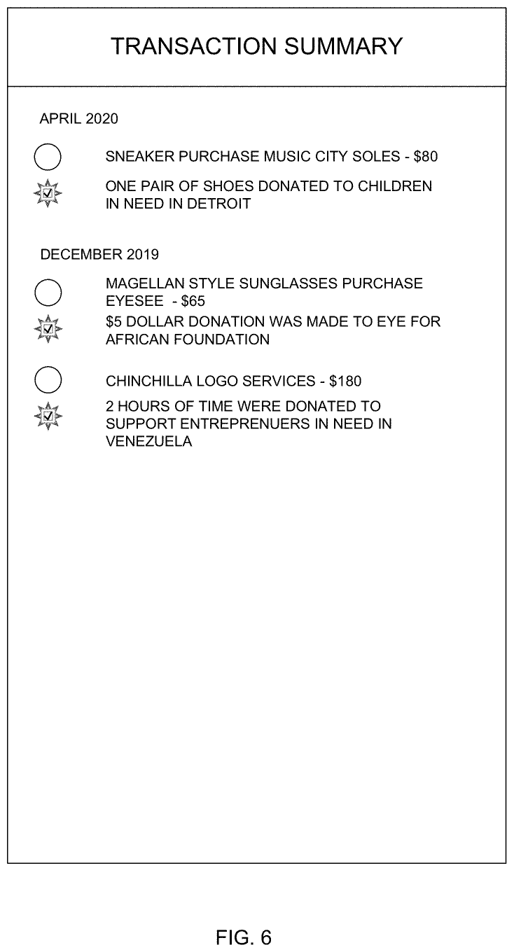

FIG. 6 is a pictorial representation of a transaction summary 600 in accordance with an illustrative embodiment. The transaction summary 600 shows a sample window, email, message, in-application message, or graphical user interface that may be displayed to a user. The transaction summary 600 may present information regarding purchases or transactions performed by a user or group of associated users. In one embodiment, the transaction summary 600 may provide details about the transaction, such as date, time, location, goods/services purchased, seller, taxes, causes supported/actions taken, and levels of cause support (e.g., in-kind donation, monies contributed, hours contributed, etc.).

The communicated or displayed data and information of the transaction summary 600 may be filtered or displayed based on user, date/date range, seller/business, types of goods/services, causes/charities supported, types of cause contributions (e.g., donations, items, hours, etc.), and other applicable transaction or cause-based information and data. For example, the user may be given a summary for specified time periods (e.g., days, weeks, years, all, etc.). The user may also be given information regarding the contributions to specific causes.

The illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible or non-transitory medium of expression having computer usable program code embodied in the medium. The described embodiments may be provided as a computer program product, or software, that may include a machine-readable medium having stored thereon instructions, which may be used to program a computing system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object-oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

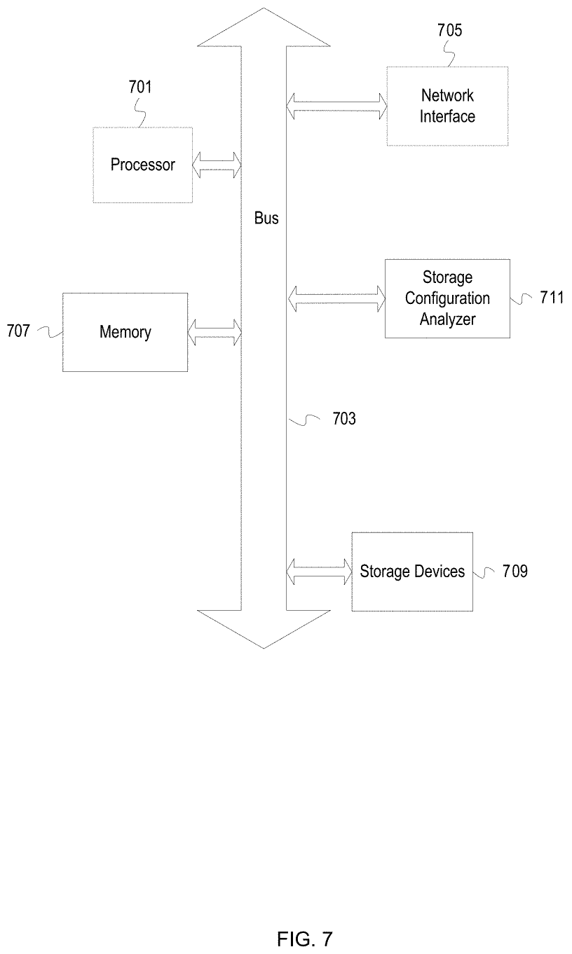

FIG. 7 depicts a computing system 700 in accordance with an illustrative embodiment. For example, the computing system 700 may represent a device, such as one or more of the devices 101 of FIG. 1. The computing system 700 may represent one or more servers function as the sale platform 120 of FIG. 1 (or other stand-alone, networked, or cloud devices). The computing system 700 includes a processor unit 701 (possibly including multiple processors, multiple cores, multiple nodes, and/or implementing multi-threading, etc.). The computing system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 703 (e.g., PCI, ISA, PCI-Express, HyperTransport®, InfiniBand®, NuBus, etc.), a network interface 705 (e.g., an ATM interface, an Ethernet interface, a Frame Relay interface, SONET interface, wireless interface, etc.), and a storage device(s) 709 (e.g., optical storage, magnetic storage, etc.). The system memory 707 embodies functionality to implement embodiments described above. The system memory 707 may include one or more functionalities that store users, sellers, causes, verification information and data, content, blockchain data, parameters, application, user profiles, and so forth. For example, the system memory 707 may include instructions or hardware for implementing the methods and processes herein described. Code may be implemented in any of the other devices of the computing system 700. Any one of these functionalities may be partially (or entirely) implemented in hardware and/or on the processing unit 701. For example, the functionality may be implemented with an application specific integrated circuit, in logic implemented in the processing unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701, the storage device(s) 709, and the network interface 705 are coupled to the bus 703. Although illustrated as being coupled to the bus 703, the memory 707 may be coupled to the processor unit 701.

The illustrative embodiments may provide a resource for consumers to make purchases in a way that supports society, charity, and other causes the consumers agree with. For example, some statistics show that 90% of shoppers are likely to switch to a cause-based product, 88% of consumers want to hear what brands are doing to have an impact, 64% of shoppers want business to integrate social impact directly into their business model, and 88% of consumers would buy a product with a social or environmental benefit.

The features, steps, and components of the illustrative embodiments may be combined in any number of ways and are not limited specifically to those described. In particular, the illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A method for compiling information for businesses supporting causes, the method comprising:
receiving information from a business supporting one or more causes;
verifying the one or more causes supported by the business;
determining whether the one or more causes are verified; and
communicating goods and services offered by the business in response to the one or more causes being verified.

2. The method of claim 1, wherein the determining whether the one or more causes are verified further comprises:
determining the one or more causes are verified;
determining whether support provided by the business regarding the one or more causes is accurate.

3. The method of claim 1, further comprising:
requesting additional information from the business and one or more causes in response to being unable to verify the one or more causes supported by the business.

4. The method of claim 1, further comprising:
adding the business as an authorized business in response to determining the one or more causes are verified.

5. The method of claim 4, further comprising:
importing information associated with the authorized business and the one or more causes.

6. The method of claim 1, further comprising:
tracking updates to the information associated with the authorized business and the one or more causes.

7. The method of claim 1, further comprising:
presenting authorized businesses in a sales platform;
displaying causes supported by each of the authorized businesses and the goods and services; and
enabling purchases of the goods and services by a plurality of consumers from the authorized businesses through the platform.

8. The method of claim 7, further comprising:
displaying the causes supported by each of the consumers based on the purchases.

9. The method of claim 7, further comprising:
communicating the causes supported by each of the consumers based on the purchases, wherein the communicating is performed utilizing preferences associated with each of the consumers.

10. The method of claim 7, further comprising:
associating the purchase with cause-based actions taken by the one or more businesses; and
associating the purchase and cause based actions with an account of the consumer.

11. The method of claim 10, further comprising:
sending a receipt of the purchases to each of the consumers indicating the purchases and the associated cause-based actions taken by the one or more businesses associated with each of the consumers.

12. A system for performing content licensing, comprising:
a plurality of electronic devices executing a sales application, the sales application is configured to display goods and services offered by a plurality of businesses;
a platform accessible by the plurality of wireless devices executing the sales application through one or more networks, wherein the platform receives information from a business supporting one or more causes, verifies the one or more causes are supported by the business, and communicates goods and services offered by the business to consumers in response to the one or more causes being verified.

13. The system of claim 12, wherein the platform determines the one or more causes are verified, and determines whether support provided by the business regarding the one or more causes is accurate.

14. The system of claim 12, wherein the platform presents the plurality of businesses, displays causes supported by each of the plurality of businesses and the goods and services, and enables purchases of the goods and services by the consumers from the plurality of businesses through the platform.

15. The system of claim 14, wherein the platform communicates the causes supported by each of the consumers based on the purchases.

16. An aggregated sales platform, comprising:
a processor for executing a set of instructions;
a memory for storing the set of instructions, wherein the instructions are executed to:
receive information from a business supporting one or more causes;
verify the one or more causes are supported by the business; and
communicate goods and services offered by the business in response to the one or more causes being verified.

17. The aggregated sales platform of claim 16, wherein the set of instructions are further executed to determine whether support purportedly provided by the business to the one or more causes is accurate.

18. The aggregated sales platform of claim 16, wherein the set of instructions are further executed to communicate the causes supported by each of the consumers based on the purchases, wherein the communicating is performed utilizing preferences associated with each of the consumers.

19. The aggregated sales platform of claim 16, wherein the set of instructions are further executed to request additional information from the business and the one or more causes in response to being unable to verify the one or more causes are supported by the business, add the business as an authorized business in response to determining the one or more causes are verified, import information associated with the authorized business and the one or more causes, and track updates to the information associated with the authorized business and the one or more causes.

20. The aggregated sales platform of claim 16, wherein the set of instructions are further executed to present authorized businesses in the aggregated sales platform, display causes supported by each of the authorized businesses, and enable purchases by a plurality of consumers from the authorized businesses through the platform.
